(19) United States
(12) Patent Application Publication
(10) Pub. No.: US 2024/0353872 A1
(43) Pub. Date: Oct. 24, 2024

(54) VALVE METERING FLOW SENSOR INTEGRATION

(71) Applicant: Danfoss A/S, Nordborg (DK)

(72) Inventors: Matjaz OSOJNIK, Ljubljana, Slovenien (SI); Bostjan DOLENC, Ljubljana (SI); Claus Kongsgard NIELSEN, Horsens (DK); Sinisa BOGAR, Vrhnika (SI); Matej POLJAK, Ljubljana (SI); Matija MATICIC, Ljubljana (SI); Martin STEPANCIC, Ljubljana (SI); Miran MUHIC, Ljubljana (SI)

(21) Appl. No.: 18/685,688

(22) PCT Filed: Aug. 30, 2022
(86) PCT No.: PCT/EP2022/070810

§ 371 Date: Feb. 22, 2024

(30) Foreign Application Priority Data
Aug. 31, 2021 (DK) PA 2021 00847

(51) Int. Cl. G05D 7/06

(52) U.S. Cl. CPC G05D 7/0635

(57) ABSTRACT

An actuator (3) for regulating a valve (1) in a fluid system is adapted to operate according to a characteristic curve (4) containing information correlating a valve opening with a flow through the valve (1) and to a flow rate measured by a flow measuring device (5), wherein, the regulation of the valve (1) is based on a modified characteristic curve (4M) that is based on a basic characteristic curve (4B) and the measured flow rate by the flow measuring device (5) compared to a design flow rate. The disclosure further relates to the method of controlling the valve.

### CROSS-REFERENCE TO RELATED APPLICATIONS

This application is a National Stage application of International Patent Application No. PCT/EP2022/070810, filed on Aug. 30, 2022, which claims priority to Danish Patent Application No. PA 2021 00847, filed Aug. 31, 2021, each of which is hereby incorporated by reference in its entirety.

### TECHNICAL FIELD

The present disclosure relates to an actuator for regulating a valve in a fluid system and a method of controlling the valve.

### BACKGROUND

Actuators for regulation a valve come in a plural of different shapes and forms, and include actuators powered by a driving mechanism operated by e.g. gas pressure, hydraulic pressure or electricity. This enables the actuators, and hence the valves, to be adjusted remotely.

Actuators may be adapted to control the valve in relation to a characteristic, also referred to as a characteristic curve, giving a relation of the flow rate to opening of the valve. Such valve flow characteristics may differ according to the actual valve, and could e.g. be linear, equal percentage, square root, modified parabolic, hyperbolic etc.

The actual flow rate may however differ from that expected according to the characteristic curve, indicating that a given setting of the actuator does not correspond to the expected flow rate.

To increase accuracy, it is known to connect the valve to a flow sensor to correct the setting, e.g. in real time in response to the differences. This however increases the significant power consumption and wears the actuator due to constant adjustments.

In some embodiments a calibration is based on changing the actuator to control according to a different among a plural of characteristic curves stored in a processor at periodical intervals when the measured flow falls outside a predetermined threshold. This has the disadvantage that the respective curve may not be the most suitable over the whole range of valve openings.

The present invention aims to introduce an actuator and method to operate the actuator where flow rate accuracy is increased over actuators operating without feedback in a substantially simple manner.

### SUMMARY

The object of the invention is solved according to the features as indicated in the claims.

This includes introducing an actuator for regulating a valve in a fluid system, wherein the actuator is adapted to operate according to a characteristic curve containing information correlating a valve opening with a flow through the valve and to a flow rate measured by a flow measuring device, where the regulation of the valve is based on a modified characteristic curve that is based on a basic characteristic curve and the flow rate measured by the flow measuring device compared to a design flow rate.

The modified characteristic curve may be calculated by a function of the basic characteristic curve.

The function may be linear or non-linear such as logarithmic, exponential, in the n'th power or of the n′th root, where ‘n’ is a natural number.

The modified characteristic curve may be calculated as a function of a basic characteristic curve and the measured flow rate, where a new modified characteristic curve is calculated when the difference between the measured flow rate and design flow rate is larger than a first threshold difference.

The modified characteristic curve may be equal to the basic characteristic curve when the measured flow rate is within a given first threshold difference to a design flow rate and calculated by the function of the basic characteristic curve when outside the given threshold difference.

The measured flow rate may be compared to the design flow according to the first threshold difference at regular time intervals t1.

The modified characteristic curve may be updated at regular time intervals t3.

The basic characteristic curve may be stored in a data storage of a controller and the calculation of the modified characteristic curve is done by a processor of the controller, where the controller forms part of the actuator.

The basic characteristic curve may be stored in a data storage of a controller and the calculation of the modified characteristic curve is done by a processor of the controller, and where the controller is external to the actuator, the actuator having means to communicate with the controller.

The flow rate measured by the flow measuring device may be based on pulses, where one pulse corresponds to a given volume of fluid flow and the flow rate depends on the frequency of the pulses.

The valve whereto the actuator of the present invention is to be connected may be a pressure independent valve. In one embodiment the present invention relates to a system formed of the actuator and the valve, where the valve could be pressure independent.

The present invention further includes a method for operating a valve within a fluid system, the method including to provide a characteristic curve containing information correlating a valve opening with a flow through the valve and to a flow rate measured by a flow measuring device, where the method is to regulate the valve according to a setting representing a design flow and to adjust the valve to a valve opening given by the characteristic curve corresponding to said design flow, wherein the characteristic curve is a modified characteristic curve calculated as a function of a basic characteristic curve and the measured flow rate, and where the method includes to calculate a new modified curve when the difference between the measured flow rate and design flow rate is larger than a first threshold difference.

The function of the method is a linear or non-linear such as logarithmic, expositional, in the n'th power or of the n'th root, where ‘n’ is a natural number.

The measured flow rate in the method may be compared to the design flow according to the first threshold difference at regular time intervals t1.

The basic characteristic curve of the method stored in a data storage of a controller and the calculation of the modified characteristic curve is done by a processor of the controller, where the controller forms part of the actuator.

The basic characteristic curve of the method may be stored in a data storage of a controller and the calculation of the modified characteristic curve is done by a processor of the controller, and where the controller is external to the actuator connected to said valve, the actuator having means to communicate with the controller.

The method may relate to controlling a pressure independent valve.

In general, throughout the text, a threshold difference is referred to in relation to a numerical difference of two values.

### BRIEF DESCRIPTION OF THE DRAWINGS

FIG. 1 illustration of an actuator connected to a valve in a flow system and where a flow measuring device further is connected

FIG. 2 illustration of a characteristic curve

FIG. 3 illustration of different types of characteristic curves

FIG. 4 illustration of a basic characteristic curve and a modified characteristic curve according to the present invention

### DETAILED DESCRIPTION

It should be understood that the detailed description and specific examples, while indicating embodiments of the invention, are given by way of illustration only.

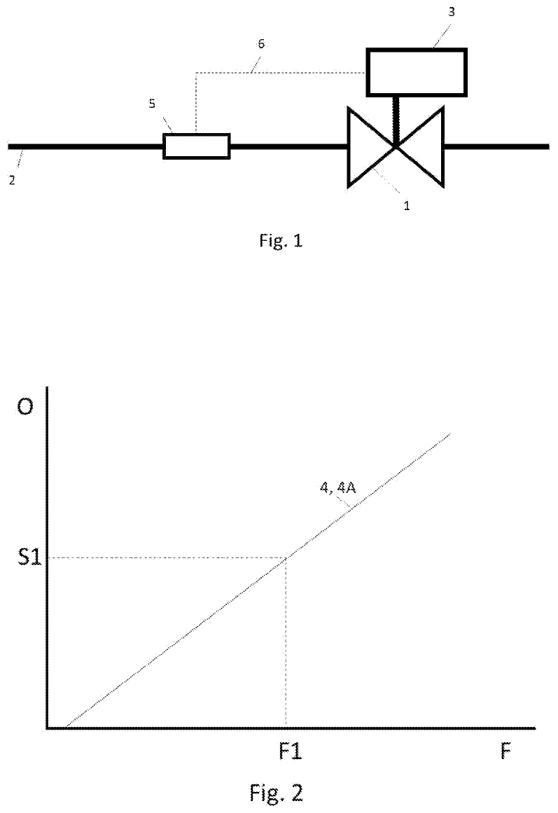

FIG. 1 illustrates a valve (1) connected to a flow conduit (2) for regulating the fluid flow through said flow conduit (2). The flow conduit (2) could form part of a heating and/or cooling system including heat exchanging devices such as radiators, floor heating systems, fluid-to-fluid heat exchangers etc. The flow conduit (2) may connect to such a heat exchanging device as supply or return conduit of fluid.

An actuator (3) is connected to the valve (1) to adjust the valve opening to correspond to a desired flow rate through the flow conduit (2).

The actuator (3) may comprise an internal controller with an internal CPU, processing means, data storage means etc. to store and process data. The actuator (3) further may comprise connection means to form data connection means to form data exchange contact to external devices like an external controller, thermostats, a BMC, laptop, smart phone etc.

The actuator (3) is operated according to a characteristic curve (4) containing information correlating a valve opening, O, (usually corresponding to a position of a valve element relative to valve seat within the valve (1)) with a flow, F, through the flow-control valve (1). Such a characteristic curve (4) is illustrated in FIG. 2. In general, the characteristic of a valve is the relationship between the flow through the valve relative to its opening, often presented in percent of respective valve opening and flow rate.

FIG. 2 illustrates the characteristic curve (4, 4A) of a linear kind, such a valve also referred to as a linear valve. In this embodiment a valve opening S1 then would correspond to a flow rate F1 in a linear relation.

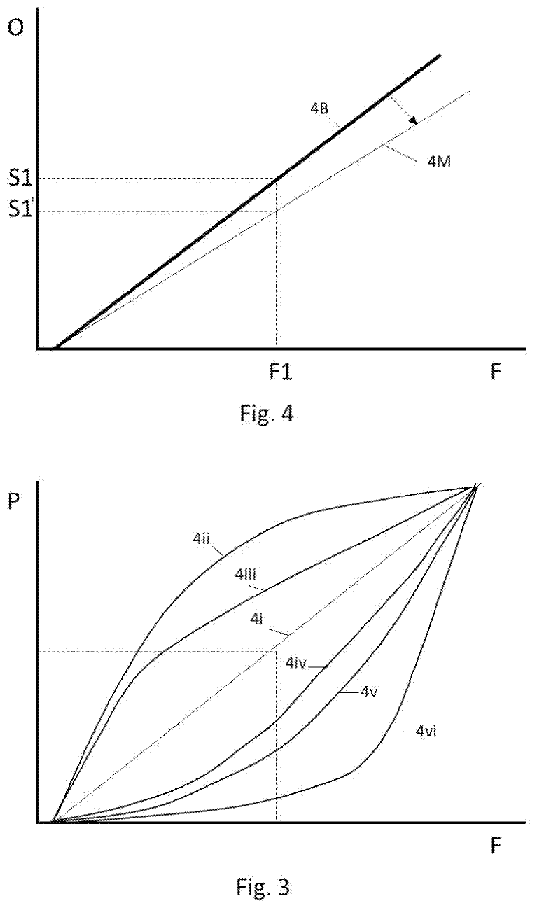

FIG. 3 illustrates examples of other kinds of characteristic curves, such as the linear (4i), Quick Opening (4ii), square root (4iii), Modified Parabolic (4iv), Equal percentage (4v) and Hyperbolic (4vi).

Back to FIG. 1, a flow sensor, or a flow measuring device (5) is connected to the flow conduit (2), such as in front of or after the valve (1) seen in the direction of flow. In this latter embodiment the flow measuring device (5) thus is connected to the same flow conduit (2) as the valve (1).

The flow measuring devices (5) may be in data exchange communication (6) with the actuator (3), or alternatively with an external controller of the actuator, and may be of any kind. One embodiment of the flow sensor (5) is based on pulse counting, where for example one pulse corresponds to a given volume of fluid flow and the flow rate depends on the frequency of the pulses. Alternatively, the flow rate could be a signal communicated (6) to in form of a voltage, e.g. 0-10 V, or 0-5 V etc, a current, digital signal etc.

Typical kinds of flow measuring devices include obstruction types, turbine types, electromagnetic, positive-displacement flowmeters, fluid dynamic, vortex shedding, anemometers, ultrasonic or Coriolis force types etc.

The valve (1) may be a pressure independent control valve, including a flow controlling part and a pressure controlling part such as to ensure a substantially constant pressure of the fluid flow in the valve (1). The actuator (3) then could be connected to the flow controlling part to adjust a valve opening to control the flow rate. Examples of such valves (1) are found in the publications EP1652014 and EP3483691.

The valve (1) is regulated in dependence to the valve characteristic curve (4), such that the actuator (3) is adapted to adjust the valve opening, O, in dependence to the expected associated flow rate, F, as indicated according to the characteristic curve (4). The expected associated flow rate F could also be referred to as the design flow, this being the requested or desired flow rate. Thus, if a design flow rate of F1 is requested, a required valve opening of S1 then is needed according to the characteristic curve (4), and the actuator (3) sets the control valve accordingly.

This may however cause errors over time of various reasons, such temperature of the fluid, ambient temperature, pressures, wear in the valve (1) or flow system etc.

The flow measuring device (5) is introduced to correct the setting of the valve (1) if the measured actual flow rate does not correspond to the requested flow rate.

It would however not be energy efficient to adjust the valve continuously based on the flow rate measurements and would also lead to quick wear of the parts, such as the valve (1).

The present invention introduces a basic characteristic curve (4B) which is constant, and a modified characteristic curve (4M) being adjusted, see also FIG. 4.

The actuator (3) in an embodiment operates according to the basic characteristic curve (4B) by adjusting the valve opening of the control valve (1) with reference to the modified characteristic curve (4M) which is based on the basic characteristic curve (4B) and the measured flow rate by the flow measuring device (5).

In one embodiment the actuator (3) comprises the means such as a processor, data memory means etc., to store the basic characteristic curve (4B). modified characteristic curve (4M), and to make the calculation of the modified characteristic curve (4M).

In another embodiment the processor, data memory means etc., to store the basic characteristic curve (4B) modified characteristic curve (4M), and to make the calculation of the modified characteristic curve (4M) forms part of a controller external to the actuator (3) then communicating a regulation signal to the actuator (3).

In another embodiment e.g. the basic characteristic curve (4B) is stored in the external controller, but the calculation of the modified characteristic curve (4M) and the setting of the valve opening is done within the actuator (3).

In an embodiment the modified characteristic curve (4M) is being calculated as a function of the basic characteristic curve (4B) and the measured flow rate by the flow measuring device.

To avoid too frequent adjustments of the valve opening of the valve (1) a first threshold may be introduced.

In an embodiment the modified characteristic curve (4M) is equal to the basic characteristic curve (4B) and where a new modified curve is calculated when the difference between the measured flow rate and design flow rate is larger than a first threshold difference. This should be explained with help of the following example.

When, for example, a flow F1 (e.g. 600 l/h) is desired, the basic characteristic curve 4B would show an opening degree of S1 (e.g. 4 mm).

However, with such an opening degree of S1, the actual flow measured by the flow meter 5 is more than F1, e.g. 660 l/h.

The difference of 660 l/h−600 l/h=60 l/h is larger than the predetermined first threshold difference. Thus, the modified characteristic curve 4M is calculated using a correction factor 660/600=1.1.

The opening degree according to the basic characteristic curve 4B is divided by the correction factor to obtain the modified characteristic curve 4M.

In the present example this will result in an opening degree S1′ of 4 mm/1.1=3.64 mm leading to the desired flow of 600 l/h corresponding to the actual flow of 600 l/h.

In other words, in the present example the slope of the basic characteristic curve 4B has been modified to obtain the modified characteristic curve 4M.

In the same manner, a second threshold may be introduced such that the valve opening is only adjusted when the difference between the measured flow rate and design flow rate is larger than a second threshold difference.

The measured flow rate may be compared to the design flow rate according to the first and/or second threshold difference at regular time intervals t1 or t2.

In another embodiment where the modified characteristic curve (4M) is updated at regular time intervals t3 independent of any threshold. In the same manner the adjustment of the valve opening based on the modified characteristic curve (4M) may be done at regular time intervals t4 rather than based on a threshold.

The present invention further relates to a method for operating the valve (1) within a fluid system. This method being to:
Introduce a characteristic curve (4) containing information correlating a valve opening with a flow through the valve (1) and to a flow rate measured by a flow measuring device (5).
Regulate the valve (1) according to a setting representing a design flow and to adjust the valve (1) to a valve opening given by the characteristic curve (4) corresponding to said design flow,
and where the method includes for the characteristic curve (4) to be a modified characteristic curve (4M) calculated as a function of a basic characteristic curve (4B) and the measured flow rate, and
to calculate a new modified curve (4M) when the difference between the measured flow rate and design flow rate is larger than a first threshold difference.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An actuator for regulating a valve in a fluid system, wherein the actuator is adapted to operate according to a characteristic curve containing information correlating a valve opening with a flow through the valve and to a flow rate measured by a flow measuring device wherein, the regulation of the valve is based on a modified characteristic curve that is based on a basic characteristic curve and the measured flow rate by the flow measuring device compared to a design flow rate.

2. The actuator according to claim 1, where the modified characteristic curve is calculated by a function of the basic characteristic curve.

3. The actuator according to claim 2, where the function is a linear or non-linear such as logarithmic, expositional, in the n'th power or of the n'th rood, where ‘n’ is a natural number.

4. The actuator according to claim 2, where the modified characteristic curve is equal to the basic characteristic curve when the measured flow rate is within a given first threshold difference to a design flow rate and calculated by the function of the basic characteristic curve when outside the given threshold difference.

5. The actuator according to claim 4, where measured flow rate is compared to the design flow according to the first threshold difference at regular time intervals t1.

6. The actuator according to claim 1, where the modified characteristic curve is updated at regular time intervals t3.

7. The actuator according to claim 1, where the basic characteristic curve is stored in a data storage of a controller and the calculation of the modified characteristic curve is done by a processor of the controller, and where the controller forms part of the actuator.

8. The actuator according to claim 1, where the basic characteristic curve is stored in a data storage of a controller and the calculation of the modified characteristic curve is done by a processor of the controller, and where the controller is external to the actuator, the actuator having means to communicate with the controller.

9. The actuator according to claim 1, where flow rate measured by the flow measuring device is based on pulses, where one pulse corresponds to a given volume of fluid flow and the flow rate depends on the frequency of the pulses.

10. A method for operating a valve within a fluid system, the method including to provide characteristic curve containing information correlating a valve opening with a flow through the valve and to a flow rate measured by a flow measuring device wherein, the method is to regulate the valve according to a setting representing a design flow and to adjust the valve to a valve opening given by the characteristic curve corresponding to said design flow and where the method includes
for the characteristic curve to be a modified characteristic curve calculated as a function of a basic characteristic curve and the measured flow rate, and
to calculate a new modified curve when the difference between the measured flow rate and design flow rate is larger than a first threshold difference.

11. The method according to claim 10, where the function is a linear or non-linear such as logarithmic, expositional, in the n'th power or of the n'th rood, where ‘n’ is a natural number.

12. The method according to claim 11, where the measured flow rate is compared to the design flow according to the first threshold difference at regular time intervals t1.

13. The method according to claim 10, where the basic characteristic curve is stored in a data storage of a controller and the calculation of the modified characteristic curve is done by a processor of the controller, and where the controller forms part of the actuator.

14. The method according to claim 10, where the basic characteristic curve is stored in a data storage of a controller and the calculation of the modified characteristic curve is done by a processor of the controller, and where the controller is external to the actuator connected to said valve, the actuator having means to communicate with the controller.

15. The method according to claim 10, wherein the method relates to controlling a pressure independent valve.

16. The actuator according to claim 3, where the modified characteristic curve is equal to the basic characteristic curve when the measured flow rate is within a given first threshold difference to a design flow rate and calculated by the function of the basic characteristic curve when outside the given threshold difference.

17. The actuator according to claim 2, where the modified characteristic curve is updated at regular time intervals t3.

18. The actuator according to claim 3, where the modified characteristic curve is updated at regular time intervals t3.

19. The actuator according to claim 4, where the modified characteristic curve is updated at regular time intervals t3.

20. The actuator according to claim 5, where the modified characteristic curve is updated at regular time intervals t3.
